(19) United States
(12) Patent Application Publication
(10) Pub. No.: US 2026/0111735 A1
(43) Pub. Date: Apr. 23, 2026

(54) METHOD AND DEVICE WITH PRUNING

(71) Applicant: SAMSUNG ELECTRONICS CO., LTD., Suwon-si (KR)

(72) Inventors: Fei CHEN, Xi’an (CN); Jongseok KIM, Suwon-si (KR); Changyong SON, Suwon-si (KR); Jonghoon YOON, Suwon-si (KR); Sung-Jae CHO, Suwon-si (KR); Yunhao ZHANG, Xi’an (CN); Zhenxin YANG, Xi’an (CN); Feng ZHU, Xi’an (CN)

(73) Assignee: SAMSUNG ELECTRONICS CO., LTD., Suwon-si (KR)

(21) Appl. No.: 19/289,259

(22) Filed: Aug. 4, 2025

(30) Foreign Application Priority Data
Oct. 22, 2024 (CN) 202411479281.3
Feb. 20, 2025 (KR) 10-2025-0022439

(51) Int. Cl. G06N 3/082

(52) U.S. Cl. CPC G06N 3/082

(57) ABSTRACT

A processor-implemented method with pruning including deactivating input channels and output channels of layers of a target model, each layer of the layers including a convolutional layer and a fully-connected layer, determining, based on a dependency relationship among the layers, a network segment set, each network segment in the network segment set including one or more of an input channel and an output channel having a dependency, an individual input channel, and an individual output channel in the target model, and activating, based on a respective importance of each network segment in the network segment set, channels of a determined number of network segments of the target model.

### CROSS-REFERENCE TO RELATED APPLICATIONS

This application claims the benefit under 35 USC § 119(a) of Chinese Patent Application No. 202411479281.3 filed on Oct. 22, 2024, in the China National Intellectual Property Administration, and Korean Patent Application No. 10-2025-0022439 filed on Feb. 20, 2025, in the Korean Intellectual Property Office, the entire disclosures of which are incorporated by reference herein for all purposes.

### BACKGROUND

### 1. Field

The following description relates to an artificial intelligence field, and more particularly, to a method and apparatus with pruning for a neural network model.

### 2. Description of Related Art

Deep learning neural networks are the core foundation of artificial intelligence and may be used in various fields such as object detection, speech recognition, and natural language processing. Modern neural networks require millions of parameters for training, and research has shown that there is a high level of redundancy among these parameters. This is why pruning techniques may be used to remove some parameters within a range that does not significantly affect the accuracy of a model. Research on pruning has been actively conducted as pruning increases the efficiency of neural networks and makes it possible to train and deploy models even on mobile devices which typically have limited resources.

Unstructured pruning is a typical method of randomly removing parameters. Recently, research on structured pruning algorithms that may efficiently execute artificial intelligence models on platforms with limited resources has been actively conducted. For example, a channel pruning algorithm may reduce the size of a model, increase the execution speed, and reduce the memory usage by removing parameters at an input/output channel level of a neural network model.

Either one of the typical unstructured or structured pruning algorithms may be closely matched or tailored to certain neural network structures. Therefore, when a pruning algorithm is applied to different neural network models, the pruning algorithm needs to be specifically adjusted according to the structure of each different neural network model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including deactivating input channels and output channels of layers of a target model, each layer of the layers including a convolutional layer and a fully-connected layer, determining, based on a dependency relationship among the layers, a network segment set, each network segment in the network segment set including one or more of an input channel and an output channel having a dependency, an individual input channel, and an individual output channel in the target model, and activating, based on a respective importance of each network segment in the network segment set, channels of a determined number of network segments of the target model.

The method may include determining a first input of each of the layers of the target model by inputting initial data to the target model prior to deactivating the input channels and the output channels of the layers of the target model.

The method may include performing first processing on each of the layers of the target model prior to the deactivating of the input channels and the output channels of the layers of the target model, the first processing including, based on setting, to a random value, an output of a first layer among the layers of the target model, determining respective subsequent inputs of each of one or more layers subsequent to the first layer by inputting the initial data to the target model, and determining one or more dependencies between the first layer and one or more dependent layers of the one or more subsequent layers based on a corresponding subsequent input being inconsistent with a corresponding first input among the one or more layers subsequent to the first layer.

The determining of the one or more dependent layers may include determining a dependency, of the one or more dependencies, between an output channel of the first layer and an input channel of the one or more dependent layers of the one or more subsequent layers of which the corresponding subsequent input is inconsistent with the corresponding first input among the one or more layers subsequent to the first layer.

The determining of the network segment set may include determining the network segment set by performing second processing on each of the layers of the target model, and the second processing may include, in response to an output channel of a first layer of the target model being deactivated, determining the output channel of the first layer as an output channel of a current network segment and performing third processing on each of one or more subsequent layers subsequent to the first layer and having dependency with the first layer, the third processing may include, in response to an input channel of a first subsequent layer subsequent to the first layer and having dependency with the first layer being deactivated, determining the input channel of the first subsequent layer as an input channel of the current network segment and determining that the current network segment is included in the network segment set.

The third processing may further include, in response to the input channel of the first subsequent layer subsequent to the first layer and having the dependency with the first layer being activated, performing fourth processing on each remaining subsequent layer subsequent to the first subsequent layer among the one or more subsequent layers subsequent to the first layer and having the dependency with the first layer and the fourth processing may include, in response to an input channel of a second subsequent layer subsequent to the first subsequent layer being deactivated, determining the input channel of the second subsequent layer as a separate network segment and determining that the separate network segment is included in the network segment set.

The third processing may further include, in response to all input channels of the one or more subsequent layers subsequent to the first layer and having the dependency with the first layer being activated, determining that the current network segment is included in the network segment set, the current network segment may only include the output channel of the first layer.

The activating of the channels of the determined number of network segments of the target model may include determining the respective importance of the each network segment based on a weight of a layer corresponding to a channel of the each network segment in the network segment set and activating channels of the determined number of network segments having a greatest importance in the network segment set.

The method may further include, in response to a ratio of activated channels of the target model failing to satisfy a determined ratio, determining a next network segment set based on the dependency relationship among the layers of the target model and activating channels of the determined number of network segments of the target model based on importance of each network segment in the next network segment set.

The method may further include repeating the determining of the next network segment set and the activating of the channels of the determined number of network segments until the ratio of the activated channels of the target model satisfies the determined ratio.

The method may further include setting weights of the layers of the target model to 0 prior to the determining of the first input of each of the layers of the target model by inputting the initial data to the target model.

In a general aspect, here is provided an electronic device including at least one processor including processing circuitry, a memory including one or more storage media configured to store instructions, and the instructions, when executed by the at least one processor individually or collectively, cause the electronic device to perform deactivating input channels and output channels of layers of a target model, each layer of the layers including a convolutional layer and a fully-connected layer, determining a network segment set based on a dependency relationship among the layers, each network segment in the network segment set may include one or more of an input channel and an output channel which have dependency, an individual input channel, and an individual output channel in the target model, and activating, based on a respective importance of each network segment in the network segment set, channels of a determined number of network segments of the target model.

The instructions may further cause the electronic device to further perform determining a first input of each of the layers of the target model by inputting initial data to the target model prior to the deactivating of the input channels and the output channels of the layers of the target model.

The instructions may further cause the electronic device to further perform first processing on each of the layers of the target model prior to the deactivating of the input channels and the output channels of the layers of the target model, and the first processing may include, based on setting, to a random value, an output of a first layer among the layers of the target model, determining respective subsequent inputs of each of one or more subsequent layers subsequent to the first layer by inputting the initial data to the target model and determining one or more dependencies between the first layer and one or more dependent layers of the one or more subsequent layers based on a corresponding subsequent input being inconsistent with a corresponding first input among the one or more subsequent layers subsequent to the first layer.

The determining of the network segment set based on the dependency relationship among the layers of the target model may include determining the network segment set by performing second processing on each of the layers of the target model, the second processing may include, in response to an output channel of a first layer of the target model being deactivated, determining the output channel of the first layer as an output channel of a current network segment and performing third processing on each of one or more subsequent layers subsequent to the first layer and having dependency with the first layer, and the third processing may include, in response to an input channel of a first subsequent layer subsequent to the first layer and having dependency with the first layer being deactivated, determining the input channel of the first subsequent layer as an input channel of the current network segment and determining that the current network segment is included in the network segment set.

The third processing may further include, in response to the input channel of the first subsequent layer subsequent to the first layer and having the dependency with the first layer being activated, performing fourth processing on each remaining subsequent layer subsequent to the first subsequent layer among the one or more subsequent layers subsequent to the first layer and having the dependency with the first layer, and the fourth processing may include, in response to an input channel of a second subsequent layer subsequent to the first subsequent layer being deactivated, determining the input channel of the second subsequent layer as a separate network segment and determining that the separate network segment is included in the network segment set.

The third processing may further include, in response to all input channels of the one or more subsequent layers subsequent to the first layer and having the dependency with the first layer being activated, determining that the current network segment is comprised in the network segment set, the current network segment may only include the output channel of the first layer.

The activating of the channels of the determined number of network segments of the target model based on the respective importance of the each network segment in the network segment set may include determining the respective importance of the each network segment based on a weight of a layer corresponding to a channel of the each network segment in the network segment set and activating channels of the determined number of network segments having a greatest importance in the network segment set.

The instructions may further cause the electronic device to further perform, in response to a ratio of activated channels of the target model failing to satisfy a determined ratio, determining a next network segment set based on the dependency relationship among the layers of the target model, activating channels of the determined number of network segments of the target model based on importance of each network segment in the next network segment set, and repeating the determining of the next network segment set and the activating of the channels of the determined number of network segments until the ratio of the activated channels of the target model satisfies the determined ratio.

In a general aspect, here is provided a non-transitory computer-readable storage medium storing one or more programs including instructions that, when executed by at least one processor of an electronic device individually or collectively, cause the electronic device to perform deactivating input channels and output channels of layers of a target model, each layer of the layers including a convolutional layer and a fully-connected layer, determining a network segment set based on a dependency relationship among the layers, each network segment in the network segment set including one or more of an input channel and an output channel which have dependency, and an individual input channel, or an individual output channel in the target model, and activating, based on a respective importance of each network segment in the network segment set, channels of a determined number of network segments of the target model.

Other features and aspects will be apparent from the following detailed description, the drawings, and the claims.

### BRIEF DESCRIPTION OF THE DRAWINGS

FIG. 1 illustrates an example method with pruning according to one or more embodiments.

FIG. 2 illustrates an example method with pruning according to one or more embodiments.

FIG. 3 illustrates an example of dependencies among different convolutional layers according to one or more embodiments.

FIG. 4A illustrates an example structure of a target model according to one or more embodiments.

FIG. 4B illustrates an example dependency relationship among convolutional layers according to one or more embodiments.

FIG. 5 illustrates an example method with pruning according to one or more embodiments.

FIG. 6 illustrates an example method with dependency relationship determination according to one or more embodiments.

FIG. 7 illustrates an example method with first input determination according to one or more embodiments.

FIG. 8 illustrates example network segments according to one or more embodiments.

FIG. 9 illustrates an example method with pruning according to one or more embodiments.

FIG. 10 illustrates an example method with candidate network segment identification according to one or more embodiments.

FIG. 11 illustrates an example target model according to one or more embodiments.

FIG. 12 illustrates an example of a dependency relationships among convolutional layers according to one or more embodiments.

FIG. 13 illustrates an example of a determined number of pieces of network segment data according to one or more embodiments.

FIG. 14 illustrates an example electronic device according to one or more embodiments.

FIG. 15 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

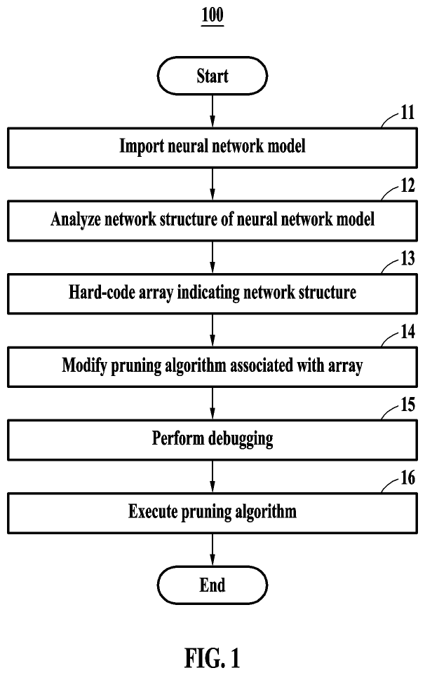

FIG. 1 illustrates an example method with pruning according to one or more embodiments.

Referring to FIG. 1, in a non-limiting example, after a neural network model is imported, method 100 may include a series of preliminary tasks to be performed to prepare for execution of a pruning algorithm.

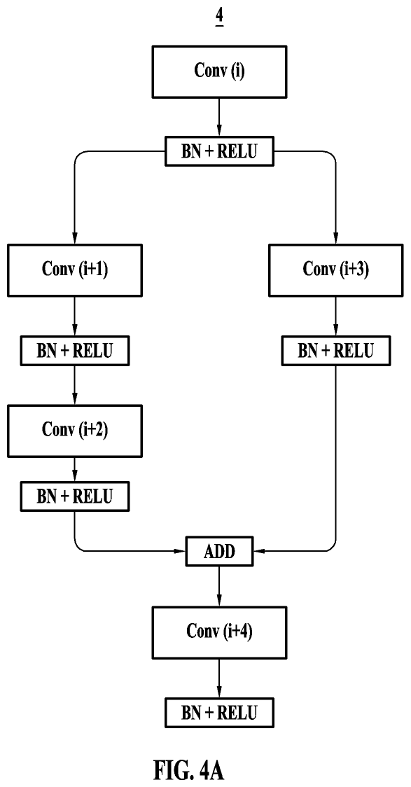

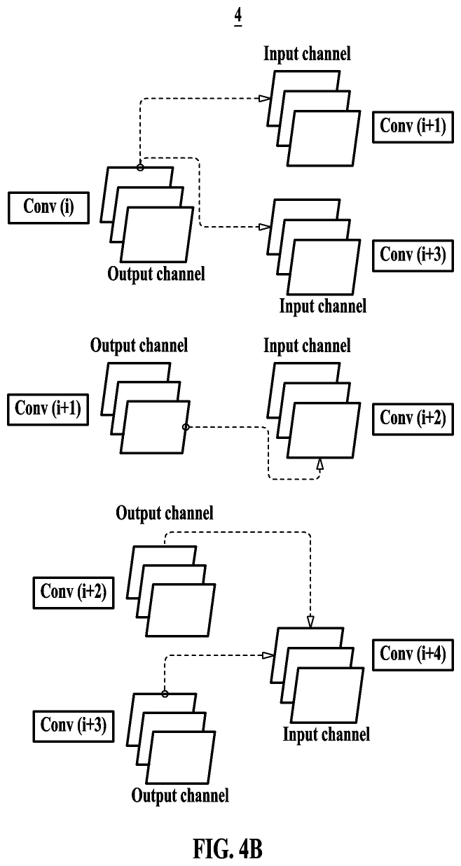

In an example, method 100 may include operation 11 where a pruning system (e.g., electronic device 1400 of FIG. 4) may import (or obtain) a neural network model. In operation 12, the pruning system may manually analyze a network structure of the neural network model. In operation 13, the pruning system may hard-code arrays representing the network structure of the neural network model. In operation 14, the pruning system may modify a pruning algorithm associated with the arrays according to a new network structure. In operation 15, the pruning system may perform a debugging process to check for an error of the modified pruning algorithm and then may execute the pruning algorithm in operation 16.

The pruning algorithm may be closely matched with or tailored (i.e., coupled with or formed together) to the network structure of the neural network model, so an algorithm may need to be appropriately adjusted to apply the pruning algorithm to the neural network model with the new network structure, as described above.

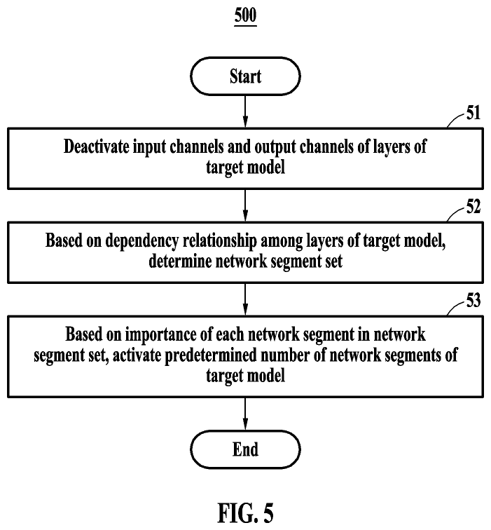

In an example, a pruning method (e.g., method 500 of FIG. 5) of the pruning system may automatically scan the network structure of the neural network model and secure the universality of the pruning algorithm through processing suitable for the network structure. The pruning method may enable the pruning algorithm to be executed on different neural network models (e.g., neural network models with different network structures) without additional modification. The pruning method may perform fast and efficient pruning for all types of neural network models (e.g., a convolutional neural network (CNN) model) while maintaining the accuracy of existing neural network model.

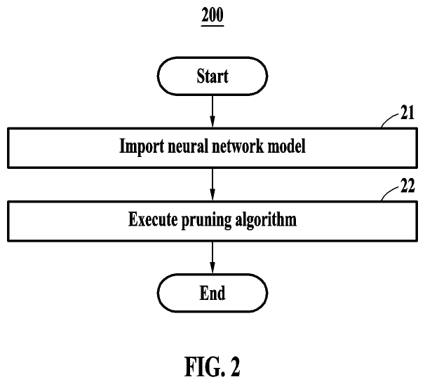

FIG. 2 illustrates an example method with pruning according to one or more embodiments.

Referring to FIG. 2, in a non-limiting example, a pruning system may perform a pruning method 200.

In an example, in operation 21 of method 200, the pruning system may import (or obtain) a neural network model.

In an example, in operation 22, the pruning system may import the neural network model and then execute a pruning algorithm without any additional modification to the neural network model.

Examples of the pruning method (e.g., method 500) may perform fast and efficient pruning for all types of neural network models (e.g., a CNN model).

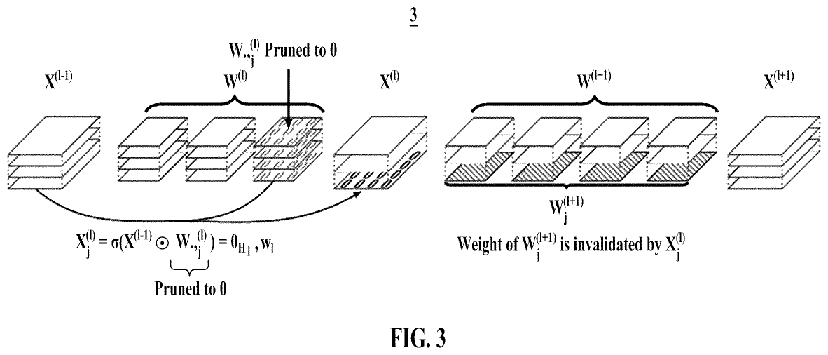

FIG. 3 illustrates an example of dependencies among different convolutional layers according to one or more embodiments.

A structured pruning method may include channel pruning. An input channel and an output channel of each layer (e.g., a convolutional layer or a fully-connected layer) of a neural network model may be independent of each other, whereas input channels and output channels of different layers may be interrelated. For example, when an output channel of a previous layer of an arbitrary layer is pruned, an input channel of the arbitrary layer may be invalidated.

Referring to FIG. 3, in a non-limited example, a partial structure of a predetermined target model 3 is illustrated. In FIG. 3, W may represent a kernel (or a filter) of a convolutional layer. When a weight of column j of W(l) is pruned to 0, the last layer of X(l) output from W(l) may become 0, which may cause a weight of row j of W(l+1) to become invalid. Therefore, inactive channels may be efficiently pruned through a dependency relationship among inputs and outputs of different layers (e.g., convolutional layers or fully-connected layers).

FIG. 4A illustrates an example structure of a target model according to one or more embodiments.

Referring to FIG. 4B, in a non-limiting example, an example of a dependency relationship among convolutional layers is illustrated.

In an example, a target model 4 may have a basic structure of a deep residual network. For example, some of the convolutional layers (e.g. Conv(i), Conv(i+1), . . . ) of the target model 4 may be related to each other.

For example, some convolutional layers are related to each other, such as Conv(i) and Conv(i+1), so an output of one convolutional layer may affect an input of another convolutional layer.

The interrelation of layers may imply that an output of a layer is directly or indirectly related (or connected) to an input of another layer so there is dependency among inputs and outputs of those layers.

The dependency relationship among layers of the target model 4 may include information concerning layers that have these types of dependencies in the target model 4.

FIG. 4B illustrates an example dependency relationship among convolutional layers according to one or more embodiments.

Referring to FIG. 4B, in a non-limiting example, the interrelated convolutional layers of the target model 4 are illustrated. For example, an output of a convolutional layer Conv(i) may affect inputs of convolutional layers Conv(i+1) and Conv(i+3). In FIG. 4B, in addition to the interrelated convolutional layers, layers such as batch normalization (BN) and a rectified linear unit (ReLU) are omitted from the illustration by merging those layers into dotted lines.

FIG. 5 illustrates an example method with pruning according to one or more embodiments.

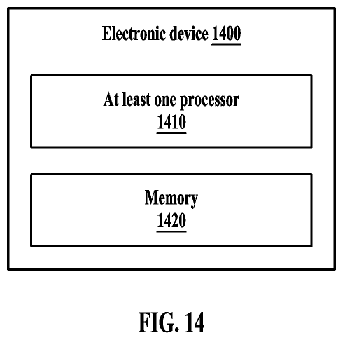

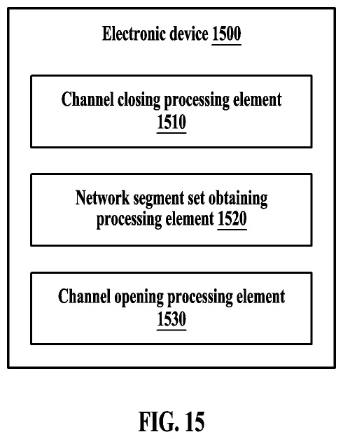

Referring to FIG. 5, in a non-limiting example, method 500 may include operations 51 to 53 which are described in greater detail below. Operations 51, 52, and 53 may be performed by an electronic device (e.g., an electronic device 1400 of FIG. 14 or an electronic device 1500 of FIG. 15). The electronic device may include at least one processor including processing circuitry. The electronic device may include at least one memory including one or more storage media including instructions. The instructions, when executed by the at least one processor individually or collectively, may cause the electronic device to perform at least some of the operations of the pruning method (e.g., method 500) of the present disclosure.

In an example, in operation 51, the electronic device may deactivate input channels and output channels of all layers (e.g., convolutional layers or fully-connected layers) of a target model.

The layers of the target model may include convolutional layers and fully-connected layers. For example, the layers of the target model may include a plurality of convolutional layers and/or a plurality of fully-connected layers.

The pruning method may optimize an existing model by deleting some of the weights of the existing model. In contrast, the pruning method may deactivate input channels and output channels of all convolutional layers and fully-connected layers of a model and then sequentially activate some network segments until a target pruning ratio is reached. Therefore, the pruning method may first require deactivation of the input channels and output channels of all layers of the target model.

For example, the target model may include a neural network model used for image processing, text processing, or speech processing. Image processing may include image recognition, image segmentation, image generation, or image class prediction, and examples are not limited thereto. Text processing may include text class prediction (e.g., politics, economics, sports, or entertainment), text sentiment prediction (e.g., positive, negative, or neutral sentiment), or text generation, and examples are not limited thereto. Speech processing may include speech recognition, speech synthesis, speech emotion prediction, or speech amplification, and examples are not limited thereto.

In an example, before operation 51 of method 500 is performed, the electronic device may determine a first input of each of one or more subsequent layers subsequent to a first layer of the target model by inputting initial data to the target model.

That is, as discussed in greater detail below, before operation 51 is performed, the electronic device may perform a first processing on each of the layers of the target model. For example, the electronic device may repeatedly perform the first processing on each of the layers of the target model, and hereinafter, the first layer may correspond to a current layer (e.g., a current convolutional layer or a current fully-connected layer) in a current iteration of the first processing. The first processing may include operations (1) and (2).

In an example, in (1), the electronic device may determine a second input of each of the one or more subsequent layers subsequent to the first layer by inputting initial data to the target model based on setting an output of the first layer of the target model to a random value.

In an example, in (2), the electronic device may also determine that there is dependency between the first layer and a second layer of which a corresponding second input is inconsistent with a corresponding first input among the one or more subsequent layers subsequent to the first layer. The electronic device may determine that there is dependency between an output channel of the first layer and an input channel of the second layer of which the corresponding second input is inconsistent with the corresponding first input among the one or more subsequent layers subsequent to the first layer. Thus, the electronic device may identify one or more respective dependencies between the first layer and subsequent layers by detecting inconsistencies in respective inputs of the subsequent layers.

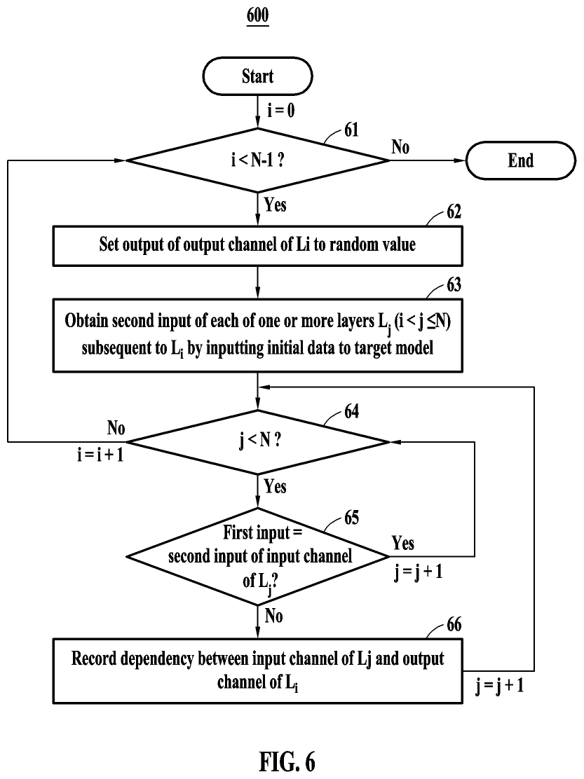

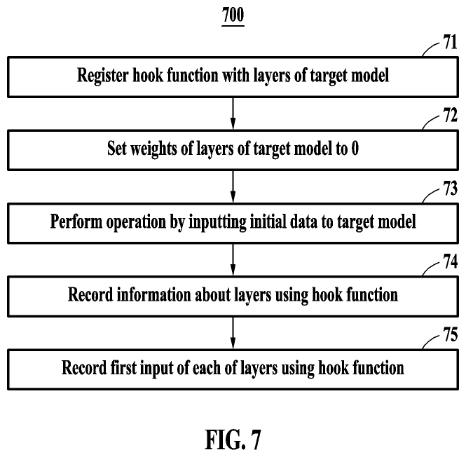

Through the first processing, inputs (e.g., the first input and the second input) of subsequent layers (e.g., a subsequent convolutional layer or a subsequent fully-connected layer) before and after an output of the current layer (e.g., the current convolutional layer or the current fully-connected layer) is set to a random value in advance are compared to see if the inputs are consistent, so it may be conveniently and quickly determined whether the output of the current layer has dependency (or a causal relationship) with any subsequent layer. The first processing is described in greater detail below with reference to FIGS. 6 and 7.

In an example, in operation 52, the electronic device may determine a network segment set based on a dependency relationship among layers of the target model.

Each network segment in the network segment set may include an input channel and an output channel that have dependency, an individual input channel, or an individual output channel in the target model.

Operation 52 may include determining the network segment set by performing second processing on each of the layers of the target model as described in greater detail below.

The electronic device may repeatedly perform the second processing on each of the layers of the target model, and hereinafter, the first layer may correspond to the current layer (e.g., the current convolutional layer or the current fully-connected layer) in a current iteration of the second processing. The second processing may include operations (1) and (2).

In an example, in (1) of the second processing, when the output channel of the first layer of the target model is deactivated, the electronic device may determine the output channel of the first layer as the output channel of the current network segment.

When the output channel of the first layer is deactivated, operation (1) may be understood as including the output channel of the first layer in the current network segment.

In an example, in (2) of the second processing, the electronic device may perform third processing on each of the one or more subsequent layers subsequent to the first layer where the subsequent layers have a dependency with the first layer, check if the input channel of that respective subsequent layer is deactivated. If the checked subsequent layer is deactivated, then an input channel of the checked subsequent layer is added the current network segment. That is, the electronic device may repeatedly perform the third processing on each of the one or more subsequent layers subsequent to the first layer and having dependency with the first layer, and hereinafter, a first subsequent layer may correspond to a current subsequent layer (e.g., a current subsequent convolutional layer or a current subsequent fully-connected layer) in a current iteration of the third processing.

In an example, the third processing may include operations (1) and (2).

In an example, in the third processing's (1), when an input channel of the first subsequent layer subsequent to the first layer and having dependency with the first layer is deactivated, the electronic device may determine the input channel of the first subsequent layer as an input channel of the current network segment.

When the input channel of the first subsequent layer is deactivated, operation (1) may be understood as including the input channel of the first subsequent layer in the current network segment.

In an example, in the third processing's operation (2), the electronic device may determine that the current network segment is included in the network segment set.

The third processing may further include operation (3).

In an example, in the third processing's operation (3), when the input channel of the first subsequent layer subsequent to the first layer and having dependency with the first layer is activated, the electronic device may perform fourth processing on each of the remaining subsequent layers subsequent to the first subsequent layer among the one or more subsequent layers subsequent to the first layer and having dependency with the first layer. That is, the electronic device may repeatedly perform the fourth processing on each of the remaining subsequent layers subsequent to the first subsequent layer among the one or more subsequent layers subsequent to the first layer and having dependency with the first layer, and hereinafter, a second subsequent layer may correspond to a current remaining subsequent layer in a current iteration of the fourth processing.

The fourth processing may include operations (i) and (ii).

In an example, in the fourth processing's operation (i), when an input channel of the second subsequent layer subsequent to the first subsequent layer is deactivated, the electronic device may determine the input channel of the second subsequent layer as a separate network segment.

When the input channel of the second subsequent layer is deactivated, operation (i) may be understood as including the input channel of the second subsequent layer in a separate network segment other than the current network segment.

In an example, in the fourth processing's operation (ii), the electronic device may determine that a separate network segment is included in the network segment set.

The third processing may further include operation (4).

In an example, in the third processing's operation (4), when all input channels of the one or more subsequent layers subsequent to the first layer and having dependency with the first layer are activated, the electronic device may determine that the current network segment is included in the network segment set. The current network segment may only include the output channel of the first layer.

Through the second processing, the third processing, and the fourth processing described above, the electronic device may determine a network segment to be added to the network segment set based on an activation state of an output channel of each layer (e.g., a convolutional layer or a fully-connected layer) of the target model and an activation state of an input channel of a next layer that has dependency with the corresponding layer. Therefore, it may be possible to avoid repeatedly activating the same channel by adding an already activated channel to the network segment set.

Through operations (1) and (2) of the third processing, the electronic device may perform the following iterative (or loop) operations on the output channel of each layer of the target model. The electronic device may check whether the output channel of the current layer (or the first layer) of the target model is activated and determine the output channel as the output channel of the current network segment when the output channel is deactivated. The electronic device may find all subsequent layers that have dependency with the current layer based on dependency relationships among the layers of the target model and sequentially perform the following iterative operations on each subsequent layer. The electronic device may check whether an input channel of the current subsequent layer (or the first subsequent layer) is activated and determine the input channel as the input channel of the current network segment when the input channel is deactivated. Therefore, the current network segment may include the output channel of the current layer and the input channel of the current subsequent layer and may be added to the network segment set.

For example, when there are two subsequent layers that have dependency with the current layer, and all input channels of each subsequent layer are deactivated, a total of three network segments may be obtained as follows. A first network segment may include an output channel of the current layer and input channels of two subsequent layers. A second network segment may include an output channel of the current layer and an input channel of one subsequent layer. A third network segment may include the output channel of the current layer and an input channel of another subsequent layer.

The electronic device may determine an activation state of an input/output channel of each layer based on a U/V arrangement set in the layers of the target model. For example, the electronic device may determine whether a corresponding output channel is already activated through an activation state of an output channel recorded in a U array of each layer. The electronic device may determine whether a corresponding input channel is already activated through an activation state of an input channel recorded in a V array of each layer.

The electronic device may perform the following iterative (or loop) operations on an output channel of each layer of the target model through operations (1), (2) and (3) of the third processing. The electronic device may determine whether the output channel of the current layer (or the first layer) of the target model is activated and determine the output channel as the output channel of the current network segment when the output channel is deactivated. The electronic device may find all subsequent layers that have dependency with the current layer based on dependency relationships among the layers of the target model and sequentially perform the following iterative operations on each subsequent layer. The electronic device may determine whether the input channel of the current subsequent layer (or the first subsequent layer) is activated and may perform the following iterative operations on each of the remaining subsequent layers subsequent to the current subsequent layer when the input channel is already activated. When an input channel of a subsequent layer subsequent to the current subsequent layer is deactivated, the electronic device may determine the input channel as an input channel of a separate network segment. Thus, a separate network segment may include an input channel of an arbitrary subsequent layer and may be added to the network segment set. Therefore, a deactivated input channel of a subsequent layer subsequent to an arbitrary subsequent layer may be prevented from being missed, and the network segment set may be further enriched.

The electronic device may perform the following repetitive (or loop) operations on the output channel of each layer of the target model through operations (1), (2) and (4) of the third processing. The electronic device may determine whether the output channel of the current layer (or the first layer) of the target model is activated and determine the output channel as the output channel of the current network segment when the output channel is deactivated. The electronic device may find all subsequent layers that have dependency with the current layer based on the dependency relationships among the layers of the target model and add the current network segment that includes only the output channel of the current layer to the network segment set when all subsequent layers are activated. Therefore, deactivated output channels having dependency with any input channels may be prevented from being missed, and the network segment set may be further enriched.

Returning to FIG. 5, in an example, in operation 53, the electronic device may activate channels of a determined number of network segments of the target model based on importance of each network segment of the network segment set.

The electronic device may determine the importance of each network segment based on a weight of a layer (or a kernel or a filter) corresponding to a channel of each network segment in the network segment set.

As described above, each network segment in the network segment set may include an input channel and an output channel that have dependency, an individual input channel, or an individual output channel in the target model. For example, a layer corresponding to a channel of a network segment may include layers corresponding to an input channel and an output channel of the network segment. For example, a layer corresponding to a channel of the network segment may include layers corresponding to individual input channels. For example, a layer corresponding to a channel of the network segment may include layers corresponding to individual output channels.

The electronic device may determine the importance of each network segment through Code 1 and Code 2 below.

### Code 1:

$$v 1 = np . sum ( np . abs ( weight ) , axis = ( 2 , 3 ) )$$

In Code 1, “weight” may represent weights of the layers (or kernels or filters) of the target model corresponding to channels of network segments.

The electronic device may determine the sum of the absolute values of all weight values in the [2, 3] dimensions of layers respectively corresponding to the channels of the network segments. In each layer, when the absolute values of the weight values are summed along axis=(2, 3), the dimensions corresponding to the height and width disappear, so v1 may represent a matrix (or tensor) of the size of the number of output channels×the number of input channels.

The electronic device may determine the importance of each network segment based on the sum (or v1) of the absolute values of all weight values in the [2, 3] dimensions of the layers respectively corresponding to the channels of the network segments determined via Code 1. For example, the electronic device may determine the maximum value, average value, or the sum of the elements (or weights) of v1 of each network segment in the network segment set as the importance of each network segment.

### Code 2:

$$v = v 1 / np . sqrt ( np . sum ( v 1 * v 1 ) )$$

Referring to Code 2, the electronic device may determine a normalized importance matrix v by dividing the sum (or v1) of the absolute values of all weight values in the [2, 3] dimensions of the layers respectively corresponding to the channels of the network segments determined through Code 1 by the size of the sum (e.g., Euclidean norm).

The electronic device may determine the importance of each network segment based on an importance matrix v of each network segment in the network segment set. For example, the electronic device may determine, as the importance of each network segment, the maximum value, the average value, or the sum of elements (or weights) of the importance matrix v of each network segment in the network segment.

“Importance” in operation 53 may be replaced with density (or a density value). That is, the electronic device may activate channels of a determined number of network segments of the target model based on the density of each network segment in the network segment set.

The electronic device may determine density based on the importance and the amount of computation (e.g., floating point operations per second (FLOPS)) of each network segment. The electronic device may determine the density of each network segment by dividing the importance of each network segment by the amount of computation.

For example, when a channel (e.g., an input channel and/or an output channel) of a network segment is a channel of a convolutional layer, the electronic device may calculate the amount of computation of the network segment using Equation 1.

$$FLOPS = 2 \times H \times W \times ( {C}_{i n} \times {K}^{2} + 1 ) \times {C}_{out} \qquad Equation l$$

In Equation 1, C₁ₙ may represent the number of channels of an input feature map, Cₒᵤₜ may represent the number of channels of an output feature map, K may represent the size of a square layer (or kernel), and H and W may represent the height and width of the output feature map, respectively.

For example, when a channel (e.g., an input channel and/or an output channel) of a network segment is a channel of a fully-connected layer, the electronic device may calculate the amount of computation of the network segment using Equation 2.

$$FLOPS = ( 2 I - 1 ) \times O \qquad Equation 2$$

In Equation 2, I may represent an input dimension, and O may represent an output dimension.

When determining the importance (or density) of each network segment, the electronic device may activate channels of a determined number of network segments having the highest importance (or density) in the network segment set.

When a ratio of activated channels of the target model does not satisfy a determined ratio, the electronic device may determine the next network segment set based on dependency relationships among layers of the target model. As described above in operation 52, the electronic device may determine the next network segment set by performing the second processing again on each of the layers of the target model. Since some channels of the target model are activated in operation 53, the next network segment set may at least partially differ from the previous network segment set. The electronic device may activate channels of a determined number of network segments of the target model based on the importance of each network segment in the next network segment set.

The electronic device may repeat an operation of determining a next network segment set and an operation of activating channels of a determined number of network segments until the ratio of the activated channels of the target model satisfies the determined ratio.

FIG. 6 illustrates an example method with dependency relationship determination according to one or more embodiments.

Operations 61 to 67 described below may be performed by an electronic device (e.g., the electronic device 1400 of FIG. 14 or the electronic device 1500 of FIG. 15). The electronic device may include at least one processor including processing circuitry. The electronic device may include at least one memory including one or more storage media including instructions. The instructions, when executed by the at least one processor individually or collectively, may cause the electronic device to perform at least some of the operations of the pruning method of the present disclosure.

Hereinafter, a dependency relationship (or a correlation relationship) among layers (e.g., convolutional layers or fully-connected layers) of a target model determined through the operations of FIG. 6 may be referenced to obtain a network segment. The dependency relationship among the layers of the target model may include information about layers that have dependency in the target model. For example, the dependency relationship among the layers of the target model may include information about whether there is dependency between an output channel of a layer and an input channel of another layer.

Referring to FIG. 6, in a non-limiting example, operations 61 to 67 of method 600 may be performed before operation 51 of method 500 as described above with respect to FIG. 5 is performed.

In an example, in operation 61, the electronic device may determine whether first processing is completed for all layers of the target model.

When the target model includes N layers (e.g., convolutional layers or fully-connected layers), L₀˜L_{N-1}, the electronic device may perform the first processing N−1 times because the last layer L_{N-1} does not have a next layer.

The electronic device may perform the first processing by repeatedly performing the following operations on each output channel of all layers of the target model. The electronic device may terminate the iteration when the first processing for all layers of the target model is completed.

In an example, in operation 62, the electronic device may set an output of an output channel U(L₁, C₁) of a current layer (e.g., a current convolutional layer or a current fully-connected layer) Lᵢ of a current iteration (or a current loop) to a random value (i is an integer greater than or equal to 0). For example, the electronic device may use a hook function to set the output of the output channel U(L₁, C₁) of the current layer to a random value. The hook function may be pre-registered for each layer of the target model.

In an example, in operation 63, the electronic device may perform a forward operation (e.g., a forward reasoning operation) by inputting any (or predetermined) initial data to the target model. The electronic device may determine a second input of each of one or more layers Lⱼ (j is an integer, i<j≤N) subsequent to the current layer Lᵢ by performing a forward operation on the initial data.

In an example, in operation 64, the electronic device may determine whether all input channels of one or more layers Lⱼ (i.e., L₁₊₁ to L_{N}) subsequent to the current layer are identified.

The electronic device may proceed to operation 65 when the comparison of the pre-obtained first and second inputs of each of one or more layers subsequent to the current layer is not completed.

Prior to operation 65, the electronic device may obtain the first input of each of one or more layers subsequent to the current layer of the target model by inputting any (or predetermined) initial data to the target model without setting the output of the current layer to a random value. In this case, the same initial data may be used to obtain the first input and the second input. Further details are described in greater detail below with reference to FIG. 7.

In an example, in operation 65, the electronic device may determine whether the pre-obtained first and second inputs of the input channel of the layer Lⱼ subsequent to the current layer are consistent with each other.

In operation 65, the electronic device may proceed to operation 64 when the first input and the second input of the input channel of the layer Lⱼ subsequent to the current layer are consistent with each other. The electronic device may determine whether the pre-obtained first and second inputs of the input channel of the next layer Lⱼ₊₁ of the current layer are consistent with each other.

In operation 65, the electronic device may proceed to operation 66 when the pre-obtained first and second inputs of the input channel of the layer Lⱼ subsequent to the current layer are inconsistent with each other.

In an example, in operation 66, the electronic device may determine that there is dependency between the current layer and the layer Lⱼ subsequent to the current layer. Particularly, the electronic device may determine that there is dependency between the output channel of the current layer and the input channel of the layer Lⱼ subsequent to the current layer.

In operation 66, for a layer of which a corresponding second input (e.g., a second input of an input channel V(L₂, C₂)) is inconsistent with a corresponding first input (e.g., a first input of an input channel V(L₂, C₂)) among one or more layers subsequent to the current layer, the electronic device may record, as U(L₁, C₁)->V(L₂, C₂), dependency between the output channel U(L₁, C₁) of the current layer and the input channel V(L₂, C₂) of the corresponding layer. The electronic device may then proceed to operation 64 again to determine whether the pre-obtained first and second inputs of the input channel of the layer Lⱼ₊₁ subsequent to the current layer are consistent with each other.

In operation 64, the electronic device may proceed to operation 61 when the comparison of the pre-obtained first and second inputs of each of one or more layers subsequent to the current layer is completed. The electronic device may additionally perform the first processing on each of one or more layers subsequent to the current layer of the target model.

FIG. 7 illustrates an example method with first input determination according to one or more embodiments.

Operations 71 to 75 described below may be performed by an electronic device (e.g., the electronic device 1400 of FIG. 14 or the electronic device 1500 of FIG. 15). The electronic device may include at least one processor including processing circuitry. The electronic device may include at least one memory including one or more storage media including instructions. The instructions, when executed by the at least one processor individually or collectively, may cause the electronic device to perform at least some of the operations of the pruning method of the present disclosure.

Operations 71 to 75 may be performed prior to operation 51 of deactivating input channels and output channels of layers of the target model of FIG. 5. The electronic device may determine a first input of each layer of the target model by inputting any (or predetermined) initial data to the target model without setting an output of the current layer to a random value.

Referring to FIG. 7, in a non-limiting example, method 700 may include operations 71 to 75 which may be performed prior to the operations for the first processing of FIG. 6. The electronic device may obtain a first input of each of one or more layers subsequent to the current layer of the target model by inputting any (or predetermined) initial data to the target model without setting the output of the current layer to a random value.

In an example, in operation 71, the electronic device may register a hook function with layers (e.g., convolutional layers or fully-connected layers) of the target model. The electronic device may scan all layers of the target model and pre-register the hook function for each layer.

In an example, in operation 72, the electronic device may set weights of all layers (e.g., convolutional layers or fully-connected layers) of the target model to 0.

For example, the electronic device may set weights of all convolutional layers and fully-connected layers to 0 by setting a U/V array for each layer of the target model. Therefore, the amount of computation may be reduced and a pruning speed can be improved during a pruning process. In this case, a layer such as BN may be ignored.

In an example, in operation 73, the electronic device may perform a forward operation (e.g., a forward inference operation) by inputting any (or predetermined) initial data to the target model. The electronic device may obtain the inputs of all layers of the target model by performing the forward operation on the initial data.

In an example, in operation 74, the electronic device may record information about layers (e.g., convolutional layers or fully-connected layers) using a hook function. The information about the layers may include, for example, the number of input channels (or input dimensions), the number of output channels (or output dimensions), the number of groups (group count), or a model structure. The electronic device may initialize at least a portion of a data structure of the target model, such as a U/V array to which activation states of an input channel and/or an output channel are recorded, the number of convolutional layers, or the number of fully-connected layers, based on the information about the layers.

In an example, in operation 75, the electronic device may record the input of each of all layers of the target model as a first input using a hook function. The electronic device may store each first input, numbered according to the operation (or execution) order of the layers, in the data structure of the target model.

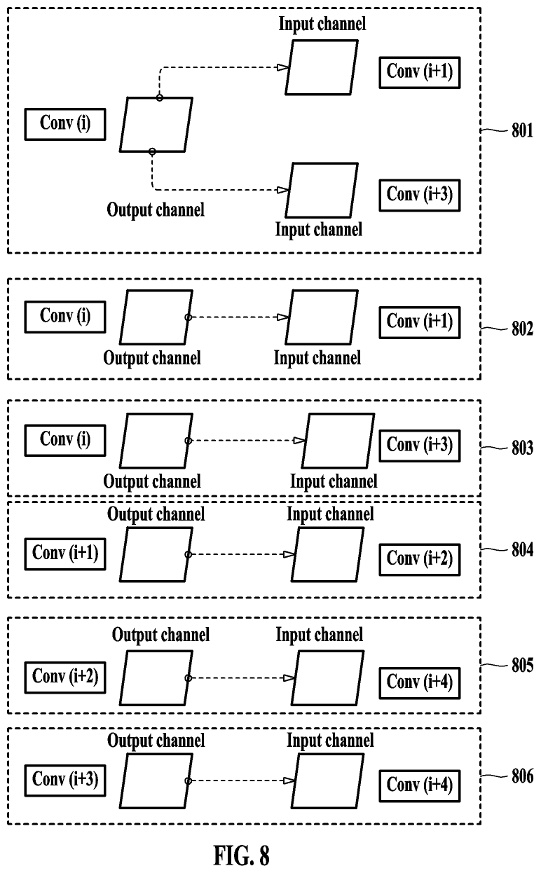

FIG. 8 illustrates example network segments according to one or more embodiments.

As described above with reference to FIGS. 4A and 4B, at least some of the layers of the target model 4 may be interrelated. The interrelation of layers may imply that an output of a layer is directly or indirectly related (or connected) to an input of another layer so there is dependency among inputs and outputs of those layers. That is, the dependency relationship among layers of the target model 4 may include information about layers that have dependency in the target model 4.

When determining the dependency relationship among the layers of the target model 4 illustrated in FIG. 4B, the electronic device may obtain a network segment set including network segments 801, 802, 803, 804, 805, and 806 illustrated in FIG. 8 based on the dependency relationship. The electronic device may use at least a portion of the network segment set for pruning processing.

Referring to FIG. 8, a network segment including an individual input channel or an individual output channel is not shown. Meanwhile, since a network segment is obtained by repeatedly performing second processing based on an output channel of an arbitrary layer, each network segment may not include any output channels or may include only one output channel. Each network segment may not include any input channels or may include one or more input channels.

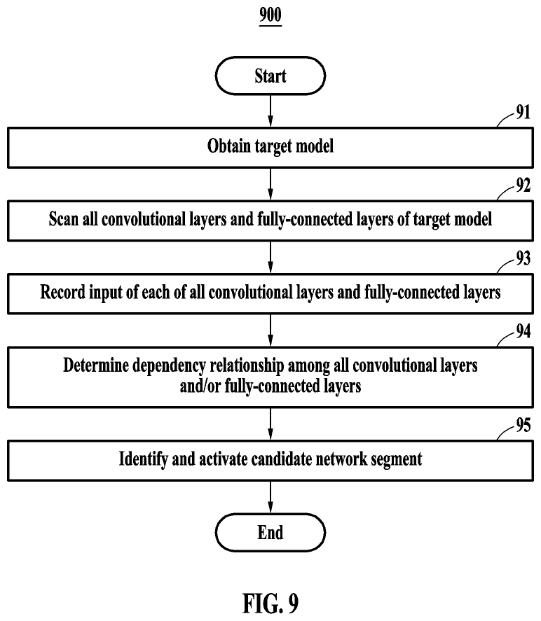

FIG. 9 illustrates an example method with pruning according to one or more embodiments.

Operations 91 to 95 described below may be performed by an electronic device (e.g., the electronic device 1400 of FIG. 14 or the electronic device 1500 of FIG. 15). The electronic device may include at least one processor including processing circuitry. The electronic device may include at least one memory including one or more storage media including instructions. The instructions, when executed by the at least one processor individually or collectively, may cause the electronic device to perform at least some of the operations of the pruning method of the present disclosure.

Referring to FIG. 9, in a non-limiting example, method 900 may include operation 91 where the electronic device may obtain a target model. For example, the target model may include a CNN model.

The layers of the target model may include convolutional layers and fully-connected layers. For example, the layers of the target model may include a plurality of convolutional layers and/or a plurality of fully-connected layers.

In an example, in operation 92, the electronic device may scan (or retrieve) all convolutional layers and fully-connected layers of the target model. That is, the electronic device may obtain and store all convolutional layers and fully-connected layers of the target model through a hook function.

In an example, in operation 93, the electronic device may record the input of each of all convolutional layers and fully-connected layers. For example, the electronic device may determine and store the inputs (e.g., first inputs and second inputs) of all convolutional layers and fully-connected layers through the hook function while setting weights of all convolutional layers and fully-connected layers to 0.

The descriptions of the operations of FIG. 7 may apply to operations 92 and 93.

In an example, in operation 94, the electronic device may determine dependency relationships among all convolutional layers and/or fully-connected layers. The electronic device may store the dependency relationships among all convolutional layers and/or fully-connected layers.

The descriptions of the operations of FIG. 6 may apply to operation 94.

In an example, in operation 95, the electronic device may identify a candidate network segment. The candidate network segment may represent a determined number of the most meaningful network segments (e.g., network segments with the highest importance) in a network segment set. The electronic device may activate a candidate network segment (or a channel of a candidate network segment).

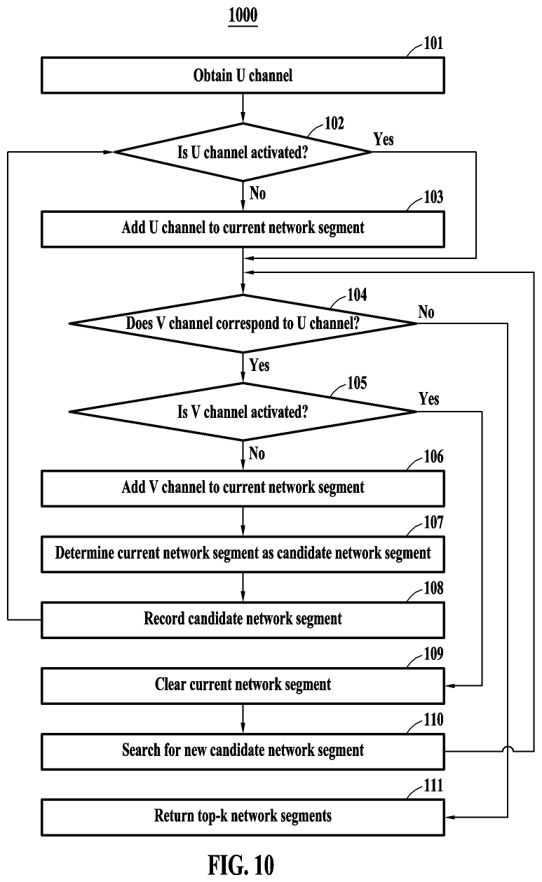

A method of identifying a candidate network segment is described in greater detail below with reference to FIG. 10.

FIG. 10 illustrates an example method with candidate network segment identification according to one or more embodiments.

Operations 101 to 111 described below may be performed by an electronic device (e.g., the electronic device 1400 of FIG. 14 or the electronic device 1500 of FIG. 15). The electronic device may include at least one processor including processing circuitry. The electronic device may include at least one memory including one or more storage media including instructions. The instructions, when executed by the at least one processor individually or collectively, may cause the electronic device to perform at least some of the operations of the pruning method of the present disclosure.

As described above with reference to FIG. 5, the electronic device may determine a network segment set based on a dependency relationship among layers of a target model. The electronic device may determine the network segment set by performing second processing on each of the layers of the target model. Hereinafter, operations 101 to 111 relate to performing a current iteration of the second processing on any current layer (e.g., a first layer) of the target model.

Referring to FIG. 10, in a non-limiting example, method 1000 may include operation 101 in which the electronic device may obtain (or determine) a U channel of the current iteration.

That is, the electronic device may obtain an output channel of the current layer (e.g., the first layer) of the current iteration of the second processing.

In an example, in operation 102, the electronic device may determine whether the U channel is already activated, that is, already opened, according to a U array.

In an example, in operation 103, when the U channel is deactivated, the electronic device may add the U channel to a current network segment. That is, when the output channel of the current layer of the current iteration is deactivated, the electronic device may determine the output channel as an output channel of the current network segment.

In an example, in operation 104, the electronic device may perform illustrated iteration processing on every V channel corresponding to the U channel of the current iteration.

A V channel corresponding to the U channel of the current layer (e.g., the first layer) of the current iteration may be input channels of one or more subsequent layers having dependency with the current layer. That is, the electronic device may repeatedly perform third processing on each of the subsequent layers that have dependency with the current layer (e.g., the first layer).

In an example, in operation 105, the electronic device may determine whether the V channel of the current iteration is already activated, that is, already opened.

That is, the electronic device may determine whether the input channel of a current subsequent layer (e.g., a first subsequent layer) of the current iteration of the third processing is already activated.

In operation 105, if the V channel of the current iteration is not activated, the electronic device may proceed to operation 106.

In an example, in operation 106, the electronic device may add the V channel to the current network segment when the V channel is deactivated. That is, when the input channel of the current subsequent layer of the current iteration is deactivated, the electronic device may determine the input channel as the input channel of the current network segment.

In an example, in operation 107, the electronic device may determine the current network segment as a candidate network segment.

In an example, in operation 108, the electronic device may record information about the candidate network segment. For example, the electronic device may determine that the candidate network segment is included in the network segment set.

Again, in operation 105, if the V channel of the current iteration is activated, the electronic device may proceed to operation 109.

In an example, in operation 109, when the V channel is already activated, that is, already opened, the electronic device may clear (or remove) the current network segment.

In an example, in operation 110, the electronic device may initiate a search for a new candidate network segment. When a V channel among all V channels subsequent to the activated V channel is deactivated, the electronic device may determine the deactivated V channel as the only candidate network segment.

In this case, the candidate network segment may only include V channels.

In an example, in operation 111, the electronic device may return a determined number of network segments when the second processing is repeatedly performed on each of all layers of the target model. For example, the electronic device may activate channels of the returned network segments by returning the top K network segments with the highest importance among candidate network segments (or a network segment set).

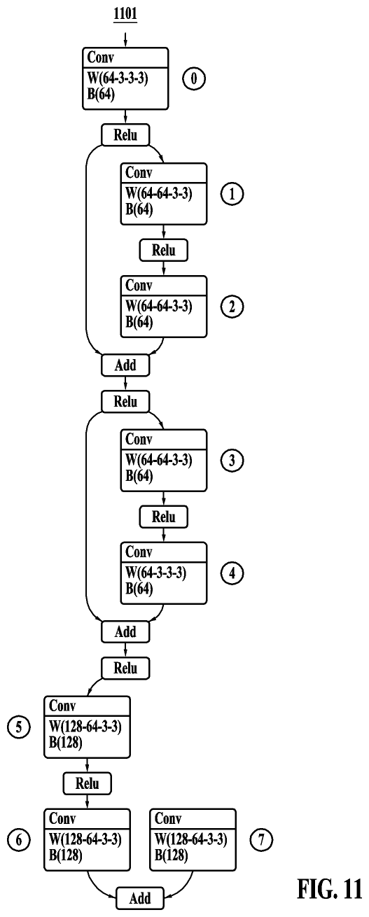

A pruning method of a target model is described with reference to FIGS. 11 to 13.

FIG. 11 illustrates an example target model according to one or more embodiments. Referring to FIG. 11, in a non-limiting example, some layers (e.g., convolutional layers) of a target model 1101 may be related to each other.

As described with reference to FIGS. 6 and 7, an electronic device may determine a dependency relationship among layers of the target model 1101. The dependency relationship among the layers of the target model 1101 may include information about layers that have dependency in the target model 1101. For example, the dependency relationship among the layers of the target model 1101 may include information about whether there is dependency between an output channel of an arbitrary layer and an input channel of another layer.

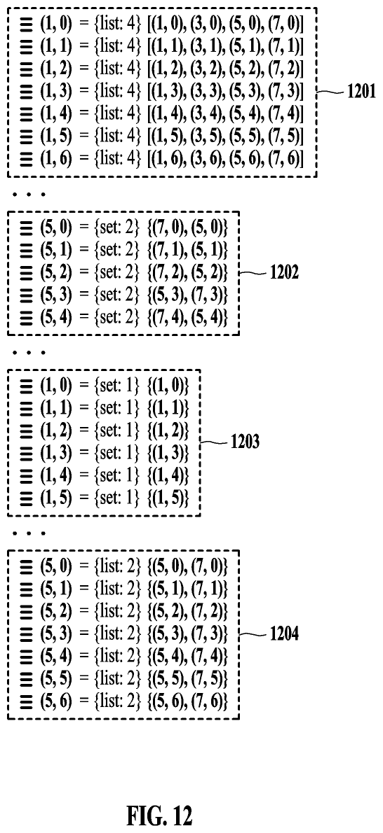

FIG. 12 illustrates an example of a dependency relationships among convolutional layers according to one or more embodiments.

Referring to FIG. 12, in a non-limiting example, a dependency relationship among convolutional layers of the target model 1101 of FIG. 11 is illustrated. In data 1201, 1202, 1203, and 1204 of FIG. 12, (n, m) before the equal signs may represent channel m of an (n−1)-th convolutional layer (or Conv n−1) in FIG. 11, and the parentheses (x, y) after the equal signs may represent channel y of an x-th convolutional layer (or, Conv x) in FIG. 11.

Data 1201 of FIG. 12 may represent a dependency relationship among some channels of Conv 0 of FIG. 11. Referring to FIG. 11, Conv 0 may have 64 output channels and 3 input channels. The data 1201 shows dependency relationships among output channels 0 to 6. For example, the first row of the data 1201 may indicate that there is dependency between the output channel 0 of Conv 0 and the input channel 0 of Conv 1, 3, 5, and 7.

Data 1202 of FIG. 12 may represent dependency relationships among some channels of Conv 4 of FIG. 11. For example, the first row of the data 1202 may indicate that there is dependency between the output channel 0 of Conv 4 and the input channel 0 of Conv 7 and 5.

Data 1203 of FIG. 12 may represent direct dependency relationships among some channels of Conv 0 of FIG. 11. For example, the data 1203 may indicate that there is direct dependency (or a direct connection) between the output channel 0 of Conv 0 and some input channels of Conv 1. The first row of the data 1203 may indicate that there is direct dependency between the output channel 0 of Conv 0 and the input channel 0 of Conv 1. Having direct dependency may indicate that both channels are connected only through one ReLU.

Data 1204 of FIG. 12 may represent direct dependency relationships among some channels of Conv 4 of FIG. 11. For example, the first row of the data 1204 may indicate that there is direct dependency between the output channel 0 of Conv 4 and the input channel 0 of Conv 5 and 7.

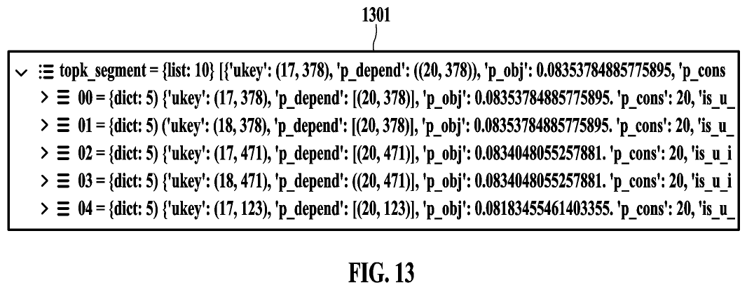

FIG. 13 illustrates an example of a determined number of pieces of network segment data according to one or more embodiments.

As described with reference to FIGS. 11 and 12, an electronic device may determine a dependency relationship among layers of the target model 1101. The electronic device may determine a network segment set based on the dependency relationship among the layers of the target model 1101.

The electronic device may activate channels of a determined number of network segments of the target model 1101 based on the importance of each network segment in the network segment set. The electronic device may determine, for example, the top 10 network segments with high importance, such as data 1301 of FIG. 13, in the network segment set.

The data 1301 shows only some of the 10 network segments. The electronic device may perform a pruning task by activating channels of a determined number of network segments in the target model 1101.

FIG. 14 illustrates an example electronic device according to one or more embodiments.

Referring to FIG. 14, in a non-limiting example, electronic device 1400 may include at least one processor (hereinafter, “processor”) 1410 including processing circuitry and a memory 1420 including one or more storage media storing instructions. When executed by the processor 1410 individually or collectively, the instructions may cause the electronic device 1400 to perform at least some of the operations described with reference to FIGS. 1 to 13 of the present disclosure.

The electronic device 1400 may include a communicator (not shown) that is connected to the processor 1410 and the memory 1420 to transmit and receive data to and from the processor 1410 and the memory 1420. The communicator may be connected to another external device and transmit and receive data to and from the external device. Hereinafter, transmitting and receiving “A” may refer to transmitting and receiving “information or data indicating A”.

The communicator may be implemented as circuitry in the electronic device 1400. For example, the communicator may include an internal bus and an external bus. In another example, the communicator may be an element that connects the electronic device 1400 to the external device. The communicator may be an interface. The communicator may receive data from the external device and may transmit the data to the processor 1410 and the memory 1420.

The processor 1410 may process data received by the communicator and/or data stored in the memory 1420. A “processor” may be a hardware-implemented data processing device having a physically structured circuit to execute desired operations. For example, the desired operations may include code or instructions included in a program. For example, the hardware-implemented data processing device may include a microprocessor, a central processing unit (CPU), a graphics processing unit (GPU), a processor core, a multi-core processor, a multiprocessor, an application-specific integrated circuit (ASIC), or a field-programmable gate array (FPGA).

The processor 1410 may control other components (e.g., a hardware or software component) of the electronic device 1400 and may perform various types of data processing or operations. As at least a part of data processing or operations, the processor 1410 may store instructions or data received from another component (e.g., the communicator) in at least a portion of the memory 1420, may process the instructions or the data stored in the memory 1420, and may store result data in the memory 1420. Operations performed by the processor 1410 may be substantially the same as the operations of the electronic device 1400.

The memory 1420 may store information necessary for the processor 1410 to perform a processing operation. The memory 1420 (or one or more storage media included in the memory 1420) may store instructions executed by the processor 1410 and may store related information while software or a program is executed by the electronic device 1400. For example, the memory 1420 may include one or more memories, which are volatile and/or non-volatile memories known in the field, such as random-access memory (RAM), dynamic RAM (DRAM), static RAM (SRAM), non-volatile RAM (NVRAM), persistent memory (PMEM), magneto-resistive RAM (MRAM), high bandwidth memory (HBM), or 3DXPoint.

The electronic device 1400 may be connected to an external memory through the communicator. For example, the external memory may include one or more volatile memories, non-volatile memories and RAM, flash memories, hard disk drives, and optical disc drives. The external memory may store an instruction set (e.g., software) for operating the electronic device 1400. The instruction set for operating the electronic device 1400 may be executed by the processor 1410.

The processor 1410 may obtain a target model. For example, the processor 1410 may obtain the target model from an external device or an external server through the communicator. For example, the processor 1410 may obtain the target model stored in the memory 1420.

The processor 1410 may determine a first input of each of one or more subsequent layers subsequent to a first layer of the target model by inputting initial data to the target model.

The processor 1410 may deactivate input channels and output channels of all layers of the target model.

The processor 1410 may perform first processing on each of the layers of the target model.

The processor 1410 may determine a network segment set based on a dependency relationship among the layers of the target model.

The processor 1410 may determine the network segment set by performing second processing on each of the layers of the target model.

The processor 1410 may activate channels of a determined number of network segments of the target model based on the importance of each network segment of the network segment set.

The electronic apparatus 1400 may correspond to various computing devices such as a high performance computer (HPC), a server computer, a desktop, or a workstation. The electronic device 1400 may be connected to an external device (e.g., a personal computer (PC) or a network) through an input/output device (not shown) to exchange data therewith. The electronic device 1400 may correspond to or be mounted on various computing devices and/or systems, such as a smartphone, a tablet computer, a laptop computer, a desktop computer, a television, a wearable device, a security system, a smart home system, and the like.

FIG. 15 illustrates an example electronic device according to one or more embodiments.

Referring to FIG. 15, in a non-limiting example, electronic device 1500 (e.g., the electronic device 1400) may include a channel closing processing element 1510, a network segment set obtaining processing element 1520, and a channel opening processing element 1530.

The electronic device 1500 may include at least some components of the electronic device 1400 described with reference to FIG. 14. For example, the electronic device 1500 may include at least one processor 1410. The electronic device 1500 may include the memory 1420.

The channel closing processing element 1510, the network segment set obtaining processing element 1520, and the channel opening processing element 1530 may be included as processing circuitry in the electronic device 1500. For example, the processing elements including the processing circuitry may be operatively coupled with at least one processor (e.g., the at least one processor 1410) of the electronic device 1500.

A memory (e.g., the memory 1420) of the electronic device 1500 may include the channel closing processing element 1510, the network segment set obtaining processing element 1520, and the channel opening processing element 1530. Depending on the implementation, a portion of the channel closing processing element 1510, the network segment set obtaining processing element 1520, and the channel opening processing element 1530 may be stored in a first memory, and another portion of the channel closing processing element 1510, the network segment set obtaining processing element 1520, and the channel opening processing element 1530 may be stored in a memory other than the first memory. Such implementation examples are not limited to the present disclosure.

The channel closing processing element 1510 may be configured to deactivate input channels and output channels of all layers (e.g., convolutional layers or fully-connected layers) of the target model.

The channel closing processing element 1510 may be configured to determine a first input of each of one or more subsequent layers subsequent to a first layer of the target model by inputting initial data to the target model before deactivating input channels and output channels of all layers of the target model.

The channel closing processing element 1510 may be configured to perform first processing on each of the layers of the target model. The channel closing processing element 1510 may be configured to determine that there is dependency between a first layer and a second layer of which a corresponding second input is inconsistent with a corresponding first input among the one or more subsequent layers subsequent to the first layer.

The channel closing processing element 1510 may be configured to set weights of layers (e.g., convolutional layers or fully-connected layers) of the target model to 0 prior to the operation of determining the first input of each of the layers of the target model by inputting the initial data to the target model.

The network segment set obtaining processing element 1520 may be configured to determine a network segment set based on the dependency relationship among the layers of the target model.

The network segment set obtaining processing element 1520 may be configured to determine the network segment set by performing second processing on each of the layers of the target model.

When an output channel of the first layer of the target model is deactivated, the network segment set obtaining processing element 1520 may be configured to determine the output channel of the first layer as an output channel of a current network segment. The network segment set obtaining processing element 1520 may be configured to perform third processing on each of the one or more subsequent layers subsequent to the first layer and having dependency with the first layer. Descriptions of the third processing overlapping with the descriptions provided with reference to FIG. 5 are omitted.

The channel opening processing element 1530 may be configured to activate channels of a determined number of network segments of the target model based on the importance of each network segment of the network segment set.

The channel opening processing element 1530 may be configured to determine the importance of each network segment based on a weight of a layer (or a kernel or a filter) corresponding to a channel of each network segment in the network segment set. The channel opening processing element 1530 may be configured to determine the next network segment set based on a dependency relationship among the layers of the target model when a ratio of activated channels of the target model does not satisfy a determined ratio. The channel opening processing element 1530 may be configured to activate channels of the determined number of network segments of the target model based on the importance of each network segment in the next network segment set. The channel opening processing element 1530 may be configured to repeat the operation of determining the next network segment set until the ratio of the activated channels of the target model satisfies the determined ratio and the operation of activating the channels of the determined number of network segments.

The electronic devices, neural networks, processors, memories, electronic device 1400, at least one processor 1410, memory 1420, electronic device 1500, channel closing processing element 1510, network segment set obtaining processing element 1520, and channel opening processing element 1530 described herein, including descriptions with respect to respect to FIGS. 1-15, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-15 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD-Rs, DVD-RWs, DVD-RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
deactivating input channels and output channels of layers of a target model, each layer of the layers comprising a convolutional layer and a fully-connected layer;
determining, based on a dependency relationship among the layers, a network segment set, wherein each network segment in the network segment set comprises one or more of an input channel and an output channel having a dependency, an individual input channel, and an individual output channel in the target model; and
activating, based on a respective importance of each network segment in the network segment set, channels of a determined number of network segments of the target model.

2. The method of claim 1, further comprising:
determining a first input of each of the layers of the target model by inputting initial data to the target model prior to deactivating the input channels and the output channels of the layers of the target model.

3. The method of claim 2, further comprising:
performing first processing on each of the layers of the target model prior to the deactivating of the input channels and the output channels of the layers of the target model,
wherein the first processing comprises:
based on setting, to a random value, an output of a first layer among the layers of the target model, determining respective subsequent inputs of each of one or more layers subsequent to the first layer by inputting the initial data to the target model; and
determining one or more dependencies between the first layer and one or more dependent layers of the one or more subsequent layers based on a corresponding subsequent input being inconsistent with a corresponding first input among the one or more layers subsequent to the first layer.

4. The method of claim 3, wherein the determining of the one or more dependent layers comprises:
determining a dependency, of the one or more dependencies, between an output channel of the first layer and an input channel of the one or more dependent layers of the one or more subsequent layers of which the corresponding subsequent input is inconsistent with the corresponding first input among the one or more layers subsequent to the first layer.

5. The method of claim 1, wherein the determining of the network segment set comprises:
determining the network segment set by performing second processing on each of the layers of the target model, wherein the second processing comprises:
in response to an output channel of a first layer of the target model being deactivated, determining the output channel of the first layer as an output channel of a current network segment; and
performing third processing on each of one or more subsequent layers subsequent to the first layer and having dependency with the first layer, and
wherein the third processing comprises:
in response to an input channel of a first subsequent layer subsequent to the first layer and having dependency with the first layer being deactivated, determining the input channel of the first subsequent layer as an input channel of the current network segment; and
determining that the current network segment is comprised in the network segment set.

6. The method of claim 5, wherein the third processing further comprises:
in response to the input channel of the first subsequent layer subsequent to the first layer and having the dependency with the first layer being activated, performing fourth processing on each remaining subsequent layer subsequent to the first subsequent layer among the one or more subsequent layers subsequent to the first layer and having the dependency with the first layer, and
wherein the fourth processing comprises:
in response to an input channel of a second subsequent layer subsequent to the first subsequent layer being deactivated, determining the input channel of the second subsequent layer as a separate network segment; and
determining that the separate network segment is comprised in the network segment set.

7. The method of claim 5, wherein the third processing further comprises:
in response to all input channels of the one or more subsequent layers subsequent to the first layer and having the dependency with the first layer being activated, determining that the current network segment is comprised in the network segment set, wherein the current network segment only includes the output channel of the first layer.

8. The method of claim 1, wherein the activating of the channels of the determined number of network segments of the target model comprises:
determining the respective importance of the each network segment based on a weight of a layer corresponding to a channel of the each network segment in the network segment set; and
activating channels of the determined number of network segments having a greatest importance in the network segment set.

9. The method of claim 1, further comprising:
in response to a ratio of activated channels of the target model failing to satisfy a determined ratio, determining a next network segment set based on the dependency relationship among the layers of the target model; and
activating channels of the determined number of network segments of the target model based on importance of each network segment in the next network segment set.

10. The method of claim 9, further comprising:
repeating the determining of the next network segment set and the activating of the channels of the determined number of network segments until the ratio of the activated channels of the target model satisfies the determined ratio.

11. The method of claim 2, further comprising:
setting weights of the layers of the target model to 0 prior to the determining of the first input of each of the layers of the target model by inputting the initial data to the target model.

12. An electronic device, comprising:
at least one processor comprising processing circuitry; and
a memory comprising one or more storage media configured to store instructions,
wherein the instructions, when executed by the at least one processor individually or collectively, cause the electronic device to perform:
deactivating input channels and output channels of layers of a target model, each layer of the layers comprising a convolutional layer and a fully-connected layer;
determining a network segment set based on a dependency relationship among the layers, wherein each network segment in the network segment set comprises one or more of an input channel and an output channel which have dependency, an individual input channel, and an individual output channel in the target model; and
activating, based on a respective importance of each network segment in the network segment set, channels of a determined number of network segments of the target model.

13. The electronic device of claim 12, wherein the instructions, when executed by the at least one processor individually or collectively, cause the electronic device to further perform:
determining a first input of each of the layers of the target model by inputting initial data to the target model prior to the deactivating of the input channels and the output channels of the layers of the target model.

14. The electronic device of claim 13, wherein the instructions, when executed by the at least one processor individually or collectively, cause the electronic device to further perform:
first processing on each of the layers of the target model prior to the deactivating of the input channels and the output channels of the layers of the target model, and
wherein the first processing comprises:
based on setting, to a random value, an output of a first layer among the layers of the target model, determining respective subsequent inputs of each of one or more subsequent layers subsequent to the first layer by inputting the initial data to the target model; and
determining one or more dependencies between the first layer and one or more dependent layers of the one or more subsequent layers based on a corresponding subsequent input being inconsistent with a corresponding first input among the one or more subsequent layers subsequent to the first layer.

15. The electronic device of claim 12, wherein the determining of the network segment set based on the dependency relationship among the layers of the target model comprises determining the network segment set by performing second processing on each of the layers of the target model,
wherein the second processing comprises:
in response to an output channel of a first layer of the target model being deactivated, determining the output channel of the first layer as an output channel of a current network segment; and
performing third processing on each of one or more subsequent layers subsequent to the first layer and having dependency with the first layer, and
wherein the third processing comprises:
in response to an input channel of a first subsequent layer subsequent to the first layer and having dependency with the first layer being deactivated, determining the input channel of the first subsequent layer as an input channel of the current network segment; and
determining that the current network segment is comprised in the network segment set.

16. The electronic device of claim 15, wherein the third processing further comprises:
in response to the input channel of the first subsequent layer subsequent to the first layer and having the dependency with the first layer being activated, performing fourth processing on each remaining subsequent layer subsequent to the first subsequent layer among the one or more subsequent layers subsequent to the first layer and having the dependency with the first layer, and
wherein the fourth processing comprises:
in response to an input channel of a second subsequent layer subsequent to the first subsequent layer being deactivated, determining the input channel of the second subsequent layer as a separate network segment; and
determining that the separate network segment is comprised in the network segment set.

17. The electronic device of claim 15, wherein the third processing further comprises:
in response to all input channels of the one or more subsequent layers subsequent to the first layer and having the dependency with the first layer being activated, determining that the current network segment is comprised in the network segment set, wherein the current network segment only comprises the output channel of the first layer.

18. The electronic device of claim 12, wherein the activating of the channels of the determined number of network segments of the target model based on the respective importance of the each network segment in the network segment set comprises:
determining the respective importance of the each network segment based on a weight of a layer corresponding to a channel of the each network segment in the network segment set; and
activating channels of the determined number of network segments having a greatest importance in the network segment set.

19. The electronic device of claim 12, wherein the instructions, when executed by the at least one processor individually or collectively, cause the electronic device to further perform:
in response to a ratio of activated channels of the target model failing to satisfy a determined ratio, determining a next network segment set based on the dependency relationship among the layers of the target model;
activating channels of the determined number of network segments of the target model based on importance of each network segment in the next network segment set; and
repeating the determining of the next network segment set and the activating of the channels of the determined number of network segments until the ratio of the activated channels of the target model satisfies the determined ratio.

20. A non-transitory computer-readable storage medium storing one or more programs comprising instructions that, when executed by at least one processor of an electronic device individually or collectively, cause the electronic device to perform:
deactivating input channels and output channels of layers of a target model, each layer of the layers comprising a convolutional layer and a fully-connected layer;
determining a network segment set based on a dependency relationship among the layers, wherein each network segment in the network segment set comprises one or more of an input channel and an output channel which have dependency, and an individual input channel, or an individual output channel in the target model; and
activating, based on a respective importance of each network segment in the network segment set, channels of a determined number of network segments of the target model.
